(19) United States
(12) Patent Application Publication
(10) Pub. No.: US 2015/0164273 A1
(43) Pub. Date: Jun. 18, 2015

(54) GRILL PAN AND GRILL COOKWARE USING THE SAME

(71) Applicant: TSANN KUEN (ZHANG ZHOU) ENTERPRISE CO., LTD., ZHANG ZHOU (CN)

(72) Inventors: NAI-CHIANG PAI, NEW TAIPEI CITY (TW); HAN-MING WU, NEW TAIPEI CITY (TW); YU-CHENG CHEN, KEELUNG CITY (TW)

(73) Assignee: TSANN KUEN (ZHANG ZHOU) ENTERPRISE CO., LTD., ZHANG ZHOU (CN)

(21) Appl. No.: 14/286,946

(22) Filed: May 23, 2014

(30) Foreign Application Priority Data
Dec. 12, 2013 (CN) 201320822528.8

(51) Int. Cl. A47J 37/06

(52) U.S. Cl. CPC A47J 37/067

(57) ABSTRACT

A grill pan includes a flat portion and two slanting portions. The slanting portions are connected to each side of the flat portion respectively. Each of the slanting portions is formed with a spout positioned opposite to where the flat portion and the slanting portion meet. The slanting portions are slightly higher than the flat portion to divide a cooking area for low-fat food and a cooking area for high-fat food, and the slanting portions slope downward from the flat portion to allow any fluid on the cooking area for high-fat food to flow toward the spout instead of the cooking area for low-fat food during cooking.

### BACKGROUND

1. Field of the Invention

The instant disclosure relates to a grill pan and a grill cookware using the same; in particular, to a grill pan having a flat portion for cooking low-fat food and two slanting portions connected to each side of the flat portion for cooking high-fat food and a grill cookware using the same.

2. Description of Related Art

People used to cook food directly in the flame to heat it up and then serve. Alternatively, grill or the like is used and food is placed on top of it to distance from the flare and prevent from burning. As technology advances, cookware in all shape and size has been well-developed to cook under bare flame or electric heating. The temperature is relatively easy to be controlled under this circumstance so as to keep the taste of the food and desired cooking status. Conventional grill pan, grill cookware or the like allows user to control the temperature and flame with ease. The food can be thoroughly cooked without burning.

However, the grill pan or grill cookware has its drawbacks. For example, when cooking meat, considerable fat is released, and the conventional grill pan or grill cookware cannot drain the excessive fat during cooking, such that the meat is constantly soaked in the fat. The meat becomes too greasy which is not good for health. In addition, the accumulated fat produces great amount of smoke during cooking. Vegetables or eggs are likely to be contaminated by the fat released from cooking the meat on the flat grill pan. Therefore, in practice, low-fat food material has to be cooked first then the high-fat food. Alternatively, after cooking the high-fat food, the cookware has to be washed before cooking low-fat food.

Furthermore, high-fat food, for example, meat, usually contains fluid. When the meat is placed on flat grill pan, the meat is soaked in its fluid and fat during cooking. The resulting food is unlikely to be tasty let alone good for health. Moreover, the flat grill pan cannot drain away excessive fat instantly, such that the fat may stick to the pan, and it can hardly be removed. In other words, the flat grill pan can be difficult to clean. To address the above issues, the inventor strives via associated experience and research to present the instant disclosure, which can effectively improve the limitation described above.

### BRIEF SUMMARY OF THE INVENTION

The instant disclosure provides a grill pan and a grill cookware using the same. The grill pan separates the fat from the food during cooking, and the fat flows away from a cooking surface, such that the food is less greasy.

According to one embodiment of the instant disclosure, the grill pan includes a flat portion and two slanting portions. The slanting portions are connected to each side of the flat portion respectively. Each of the slanting portions is formed with a spout positioned opposite to where the flat portion and the slanting portion contact. The slanting portions are slightly higher than the flat portion to divide a cooking area for low-fat food and a cooking area for high-fat food, and the slanting portions slope downward from the flat portion to allow any fluid on the cooking area for high-fat food to flow toward the spout instead of the cooking area for low-fat food during cooking.

According to another embodiment of the instant disclosure, a grill cookware is provided. The grill cookware includes a base, a grill pan, two fat tank and at least one heating tube. The grill pan includes a flat portion and two slanting portions. The slanting portions are connected to each side of the flat portion respectively. Each of the slanting portions is formed with a spout positioned opposite to where the flat portion and the slanting portion contact. The slanting portions are slightly higher than the flat portion to divide a cooking area for low-fat food and a cooking area for high-fat food, and the slanting portions slope downward from the flat portion to allow any fluid on the cooking area for high-fat food to flow toward the spout instead of the cooking area for low-fat food during cooking. The two fat tanks are disposed at a position to receive any fluid from the spout. The heating tube is disposed along a bottom face of the flat portion and the slanting portion to heat up the grill cookware.

The instant invention provides the following advantages. The height difference between the flat portion and the slanting portion divide the cooking area for low-fat food and the cooking area for high-fat food. The fat produced at the cooking area for high-fat food drains away by the slanting portion to the spout instead of the cooking area for low-fat food. The fat fast flows away from the food or the cooking area for low-fat food. Also, low-fat and high-fat food can be cooked at the same time, and the fat does not contaminate one another.

Additionally, the slanting portion reduces the time the fat remaining on the grill pan, such that smoke is greatly reduced. The clearance of the grill pan is easier because less fat sticks on the pan.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE SEVERAL VIEWS OF THE DRAWINGS

FIG. 1 is a first schematic diagram of a grill pan of the instant disclosure;

FIG. 2 is a part cross-sectional view of a grill pan of the instant disclosure;

FIG. 3 is a partial view of a grill pan of the instant disclosure;

FIG. 4 is a top view of a grill pan in accordance with an embodiment of the instant disclosure;

FIG. 5 is a top view of a grill pan in accordance with an embodiment of the instant disclosure;

FIG. 6 is a top view of a grill pan in accordance with an second embodiment of the instant disclosure;

FIG. 7 is an exploded view of a grill cookware of the instant disclosure;

FIG. 8 is a perspective view of a grill cookware of the instant disclosure; and

FIGS. 9-12 are top views showing heating tubes of grill cookware depositions.

### DETAILED DESCRIPTION OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

### First Embodiment

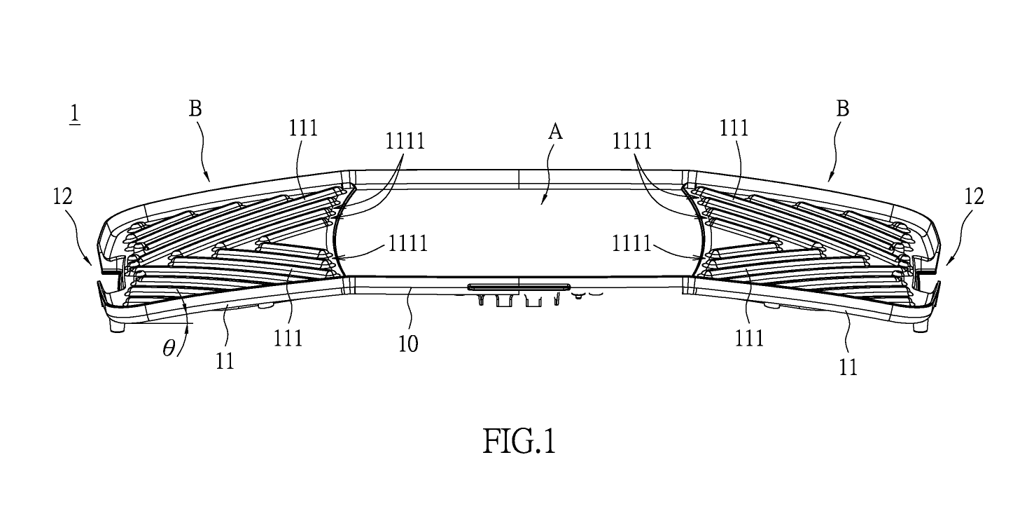

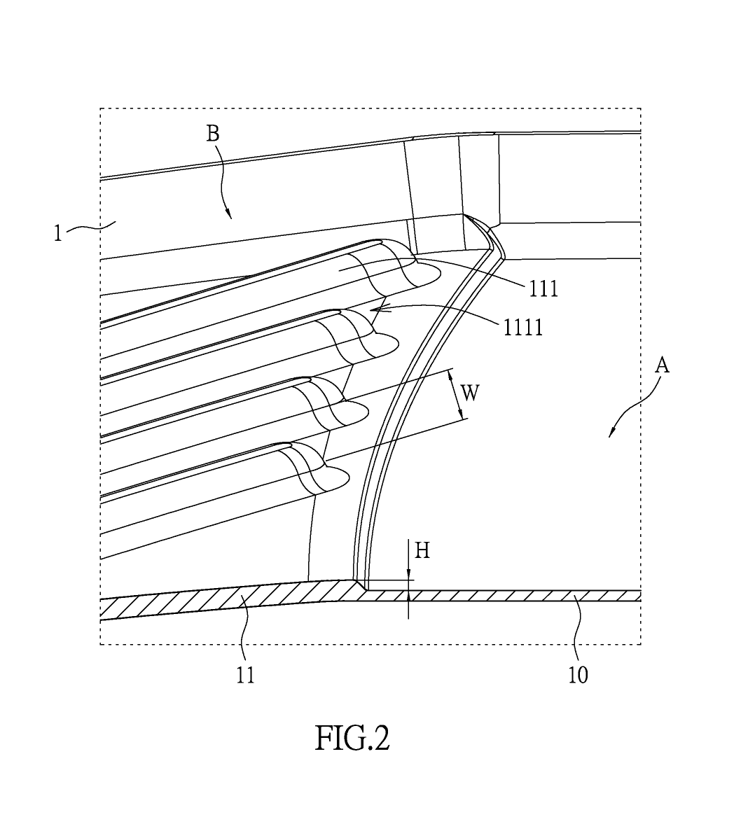

Please refer to FIGS. 1 and 2 showing a first embodiment of the instant disclosure. A grill pan 1 includes a flat portion 10 and two slanting portions 11 as shown in the figures. Each of the slanting portions 11 is connected to the opposite sides of the flat portion 10 respectively, and a height difference H is created between where the flat portion 10 and each of the slanting portions 11 meet. Therefore the flat portion 10 is slightly below the slanting portions 11. The height difference H divides a cooking area for low-fat food A and a cooking area for high-fat food B. The height difference H ranges between 1-10 mm, preferably 1.5 mm. The area of the flat portion 10 and the slanting portions 11 falls in 100-900 cm².

Each of the slanting portions 11 is a tilted structure and slopes down from where it is connected to the flat portion 10. The slanting portions 11 are formed with a spout 12 to collect fat generated during cooking food at the cooking area for high-fat food. Fat flows along the slanting portions 11 to the spout 12. As a result, during cooking high-fat food, the food is not soaked in the fat, such that the dish is light and less greasy. Additionally, the fat produced during cooking high-fat food at the cooking area for high-fat food B does not flow to the cooking area for low-fat food A, such that the low-fat food at the cooking area for low-fat food A is not contaminated by the fat.

In practice, the slanting portions 11 may tilt to any angle as desired. Preferably, an angle θ between each of the slanting portions 11 and a horizontal face may fall between 5-15 degrees. The surface of the slanting portions 11 may include a plurality of sliding prevention units (not shown), such that the high-fat food does not slide to the bottom end of the slanting portions 11. For example, bumps or ribs can serve to prevent food sliding. Furthermore, a blocking unit 1112 may be disposed close to the bottom end of the slanting portions 11 to prevent food falling to the spout 12.

The height difference between the flat portion 10 and the slanting portions 11 divide the cooking area for low-fat food A and the cooking area for high-fat food B, such that different food materials may be placed to the cooking area for low-fat food A or the cooking area for high-fat food B according the fat content. Therefore, the fat produced during cooking high-fat food at the cooking area for high-fat food B does not contaminate the low-fat food at the cooking area for low-fat food A which may alter the taste or become greasier. Also, the fat produced from the food placed on the cooking area for high-fat food B fast flow to the spout 12 because of the tilting slanting portions 11. Consequently, the high-fat food does not constantly contact the fat which is not good for health. Because the slanting portions 11 are tilted, the fat does not remain on the grill pan 1 for a long period. Therefore, less smoke is produced during cooking and the fat does not stick to the grill pan 1 which is difficult to clean.

In another embodiment, the slanting portions 11 include a plurality of ribs 111 which may be integrally formed with the slanting portion 11 and project out of the surface of the slanting portion 11. Between each two immediately adjacent ribs 111, a draining channel 1111 is formed. One end of the draining channel 1111 is close to the spout 12 so as to guide the fat in the draining channels 1111 to the spout 12. Preferably, the ribs 111 are parallel to each other, and the width W of the draining channels 1111 may fall between 3-10 mm.

Specifically, when the high-fat food is placed on top of the ribs 111 (the draining channels 1111), the fat produces during cooking flows to the draining channels 1111 and does not contact the food. Therefore the high-fat food has less fat on its surface and the dish is less greasy. Additionally, because the high-fat food does not contact the fat on the grill pan 1 during cooking, it is less likely to stick on the grill pan 1.

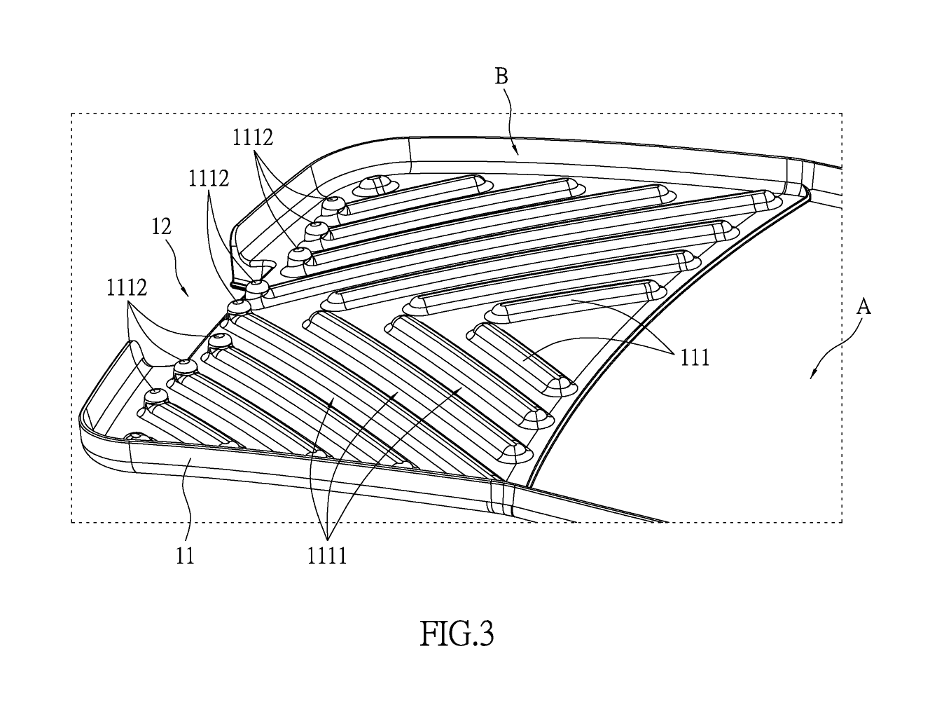

As shown in FIG. 3, the dimension of the grill pan 1 may vary according to practical requirement. In the case when the grill pan 1 is relatively large, the blocking unit 1112 may be disposed on the ribs 111 close to the spout 12 so as to prevent high-fat food on the high-fat food cooking area from sliding down to the spout 12. Preferably, the blocking unit 1112 may be integrally formed with the ribs 111. Alternatively, the blocking unit 1112 may be disposed on the grill pan 1 close to the spout 12, and the height is taller than the ribs 111. In another embodiment, the ribs 111 may have sliding prevention unit (not shown), for example, concave or convex structure or micro bumps. The sliding prevention unit increases the friction between the food and the ribs 111 so as to prevent the food from sliding into the spout 12.

It should also be noted that the grill pan 1 only needs small amount of detergent to clean up because the discrimination of the cooking area for low-fat food and the cooking area for high-fat food and on top of that the fat drainage during cooking. When the flat portion 10 of the grill pan 1 is rinsed, the water flows toward the slanting portions 11 to the spout 12. In other words, the slanting portions 11 are cleaned as the flat portion 10 is washed so as to save cleaning time. Furthermore, any water remains on the grill pan 1 will flow to the spout 12 along the slanting portions 11, therefore drying more quickly.

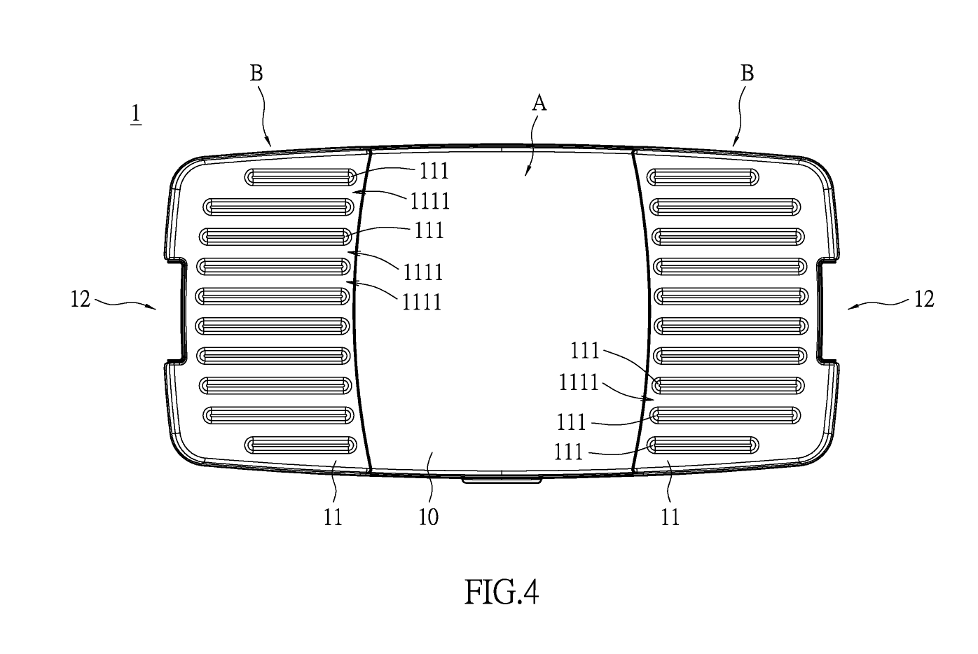

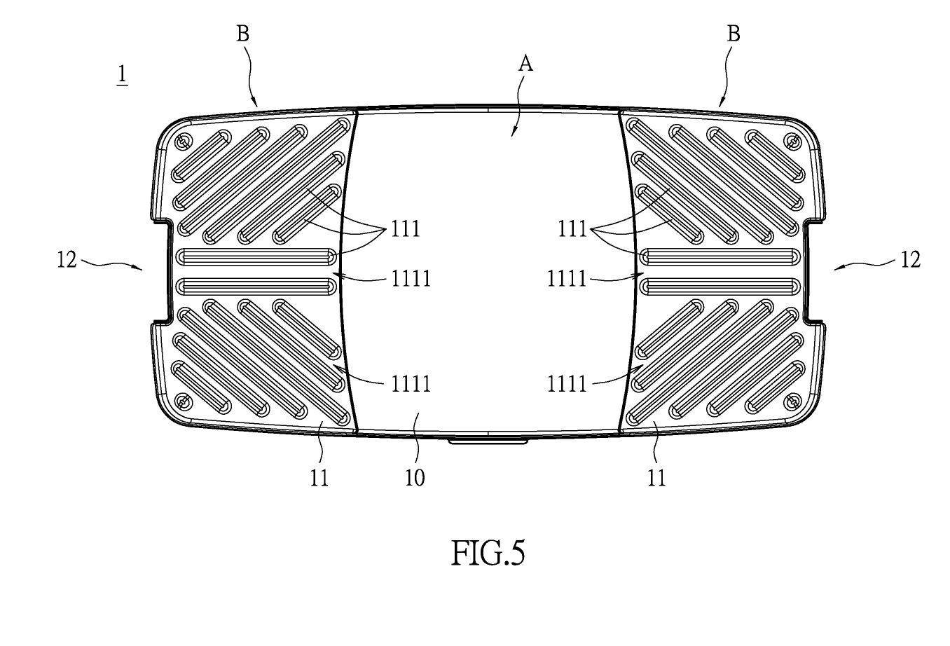

It should be understood that the arrangement of the ribs 111 in FIGS. 1 to 3 are exemplary, and the configuration may differ according to practical requirement. For example, the ribs 111 may be arranged as shown in FIGS. 4 and 5. Of course, the dimension of the spout 12 may vary according to the arrangement of different ribs 111.

### Second Embodiment

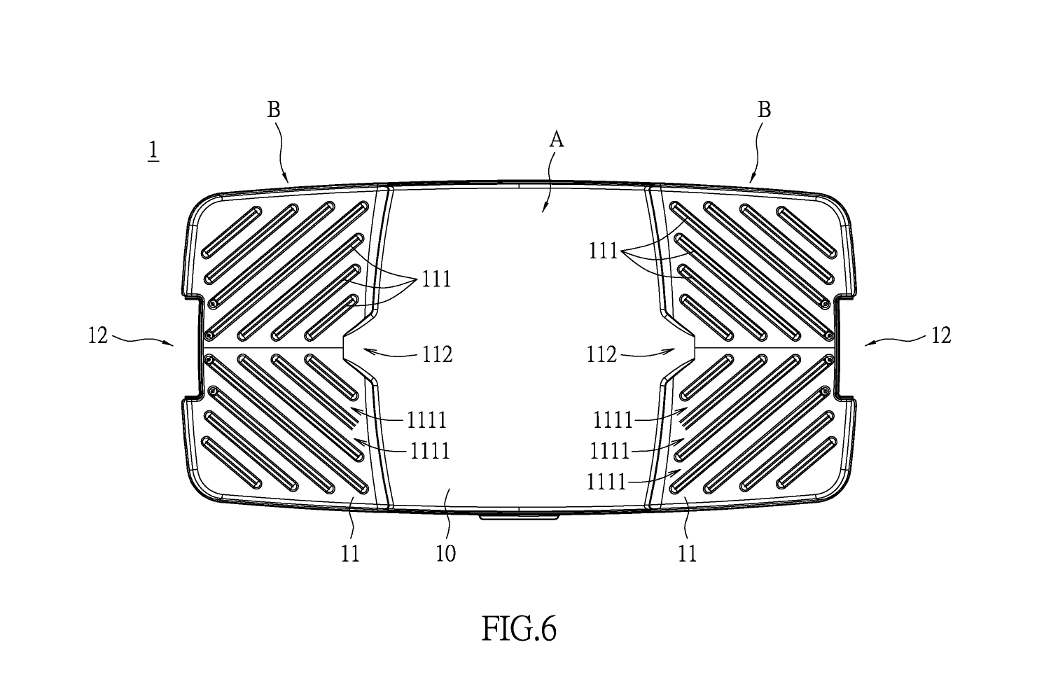

Please refer to FIG. 6, showing a top view of the grill pan in accordance with a second embodiment of the instant disclosure. The difference between the first and second embodiment arises from a guiding channel 112. The guiding channels 112 are respectively disposed on the flat portion opposite to the spouts 12. The guiding channels 112 allow fluid communication between the flat portion 10 and the slanting portions 11. The fat on the flat portion 10 produced during cooking flows through the guiding channels 112 to the slanting portions 11 and down to the spout 12. Specifically, when cooking low-fat food on the flat portion 10, fat is also produced. The fat can go through the guiding channels 112 to the spout 12, such that the flat portion 10 is free from excessive fat. Of course, fat removing equipments (for example, scraper) may be used to collect the fat on the flat portion 10 and sweep to the guiding channels 112 and then down to the spout 12. Moreover, the guiding channels 112 allow fluid communication between the flat portion 10 and the slanting portions 11, such that when rinsing the flat portion 10, the water flows out from the guiding channels 112 for easier cleaning. On the other hand, the fat or any remainders on the flat portion 10 can be cleared out from the guiding channels 112.

### Third Embodiment

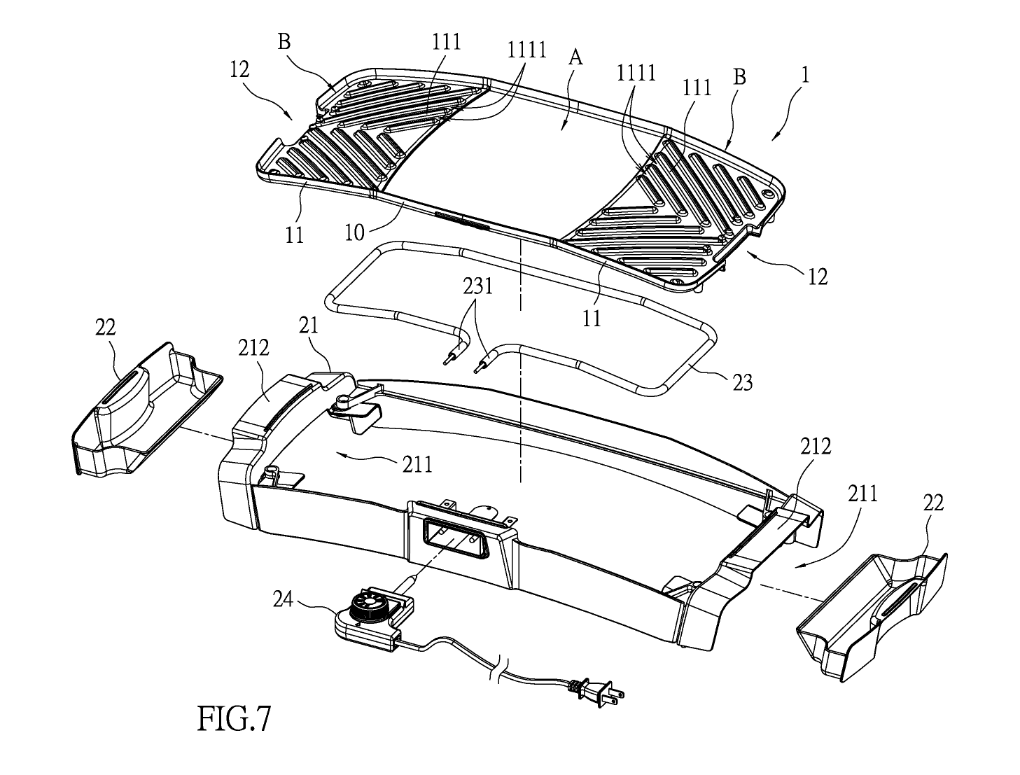

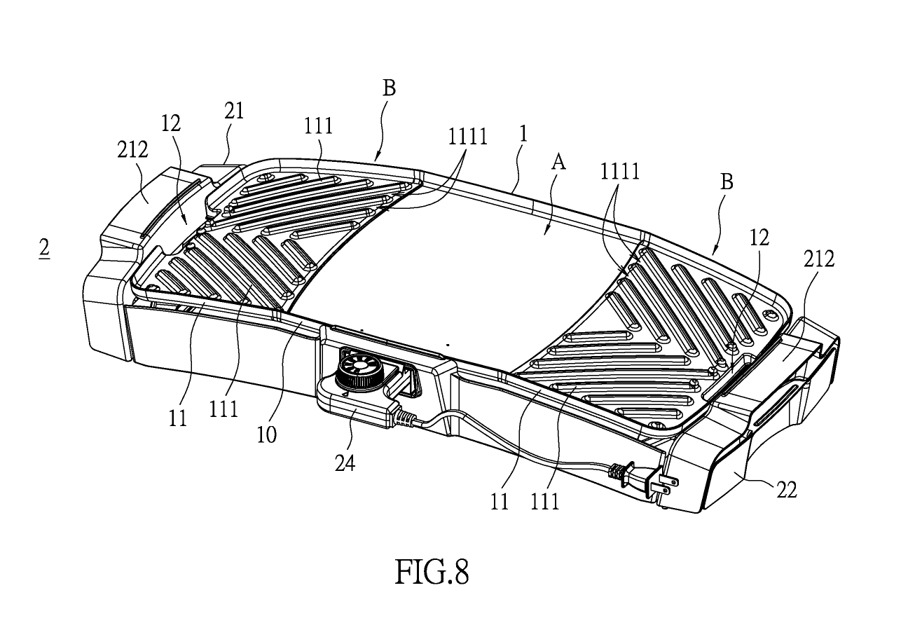

Please refer to FIGS. 7 and 8, showing schematic diagrams of a grill cookware of the instant disclosure. The grill cookware 2 includes a grill pan 1, a base 21, two fat tanks 22, at least one heating tube 23 and a control unit 24. The grill pan 1 used in the first embodiment is identical to the grill pan 1 in the second embodiment and is formed in an identical manner. Therefore, the specifics of same are not repeated herein. The grill pan 1 is disposed on the base 21. The base 21 has two fat tank holders 211 close to the spout 12 of the grill pan 1 for accommodating the fat tanks 22. The fat flowing out from the spout 12 of the grill pan 1 is collected in the fat tanks 22. The base 21 may also have two handles 212 at both ends to facilitate the grill cookware 2 handling.

In addition, the fat tanks 22 may be mechanically attached to the fat tank holders 211 of the base or through non-mechanically means. For example, each fat tank 22 may be retractably disposed on the fat tank holder 211 of the base 21. Alternatively, the fat tanks 22 may not be connected to the fat tank holder 211, such that when cleaning the grill cookware 2, the grill pan 1 and the base 21 are taken to be washed while the fat tanks 22 are left at their place. Because the fat tanks 22 do not move with the grill cookware 2, the fat in the tank does not overflow or spill out. In another embodiment, a latch (not shown) is disposed on the fat tank 22 and base 21 respectively and close to the fat tank holder 211. During cooking the latch locks the fat tank 22 to the fat tank holder 211, whereas when the grill cookware 2 needs to be cleaned and moved away, the latch unlocks the fat tank 22 from the base 21.

The heating tube 23 coils along a bottom face of the flat portion 10 and the slanting portions 11 to heat up the grill pan 1. The control unit 24 and the heating tube 23 are electrically connected to control the temperature and heating period of the heating tube 23. Preferably, the control unit 24 is detachably electrically connected to the heating tube 23. For example, the heating tube 23 may include two water-proof connecting ends 231, and the control unit 24 has two receptacles (not shown) for receiving the water-proof connecting ends 23. Each of the receptacles has a clamping portion (not shown) to secure the water-proof connecting end 231 of the heating tube 23. The clamp portion may be mechanically connected to two pressing elements (not shown) of the control unit 24. By pressing the two pressing elements of the control unit 24, the clamp portion releases the water-proof connecting end 231, such that the control unit 24 is separated from the heating tube 23. When the control unit 24 is removed, the grill pan 1 and the base 21 can be washed, and the electronic elements in the control unit 24 are spared from any damage caused by water.

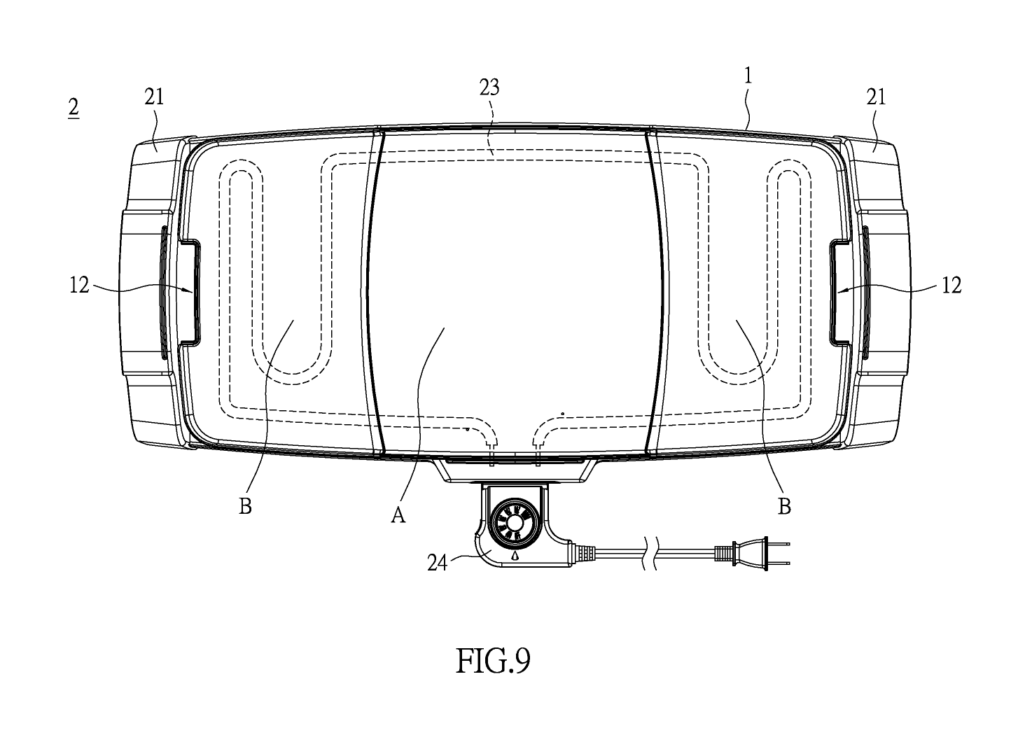

It should be noted, as shown in FIGS. 9 to 12, in practice, the heating tube 23 coils at the bottom face of the slanting portions 11. Alternatively, more than one heating tubes 23 are disposed at the bottom face of the slanting portions 11, such that the cooking area for high-fat food B of the slanting portions 11 is a high-temperature heating area. That is to say, the cooking area for high-fat food B has higher cooking temperature compared to the cooking area for low-fat food A to shorten the cooking time of food placed on the cooking area for high-fat food B. Consequently, the cooking time difference between the high-fat and low-fat food is minimized.

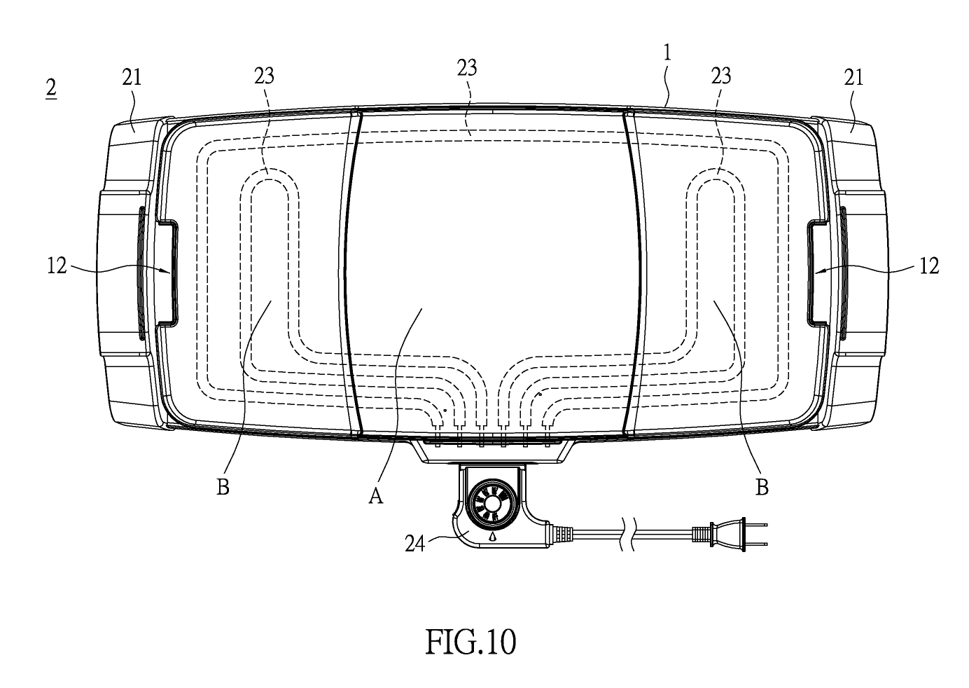

Specifically, as shown in FIG. 9 which shows a top view of the grill pan 1, the heating tube 23 coils one more loop at the bottom face of the slanting portions 11. As a result, the slanting portions 11 (i.e., cooking area for high-fat food B) has higher heating temperature than the flat portion 10 (i.e., the cooking area for low-fat food A). Alternatively, as shown in FIG. 10, the slanting portions 11 (i.e., cooking area for high-fat food B) has one more heating tube 23, such that the slanting portions 11 are high temperature heating area. Further still, the grill pan 1 may have two heating tubes 23 encircling different regions, and the inner heating tube 23 is disposed at the central region of the slanting portion 11, such that the cooking temperature at the slanting portions 11 is higher than that of the flat portion 10.

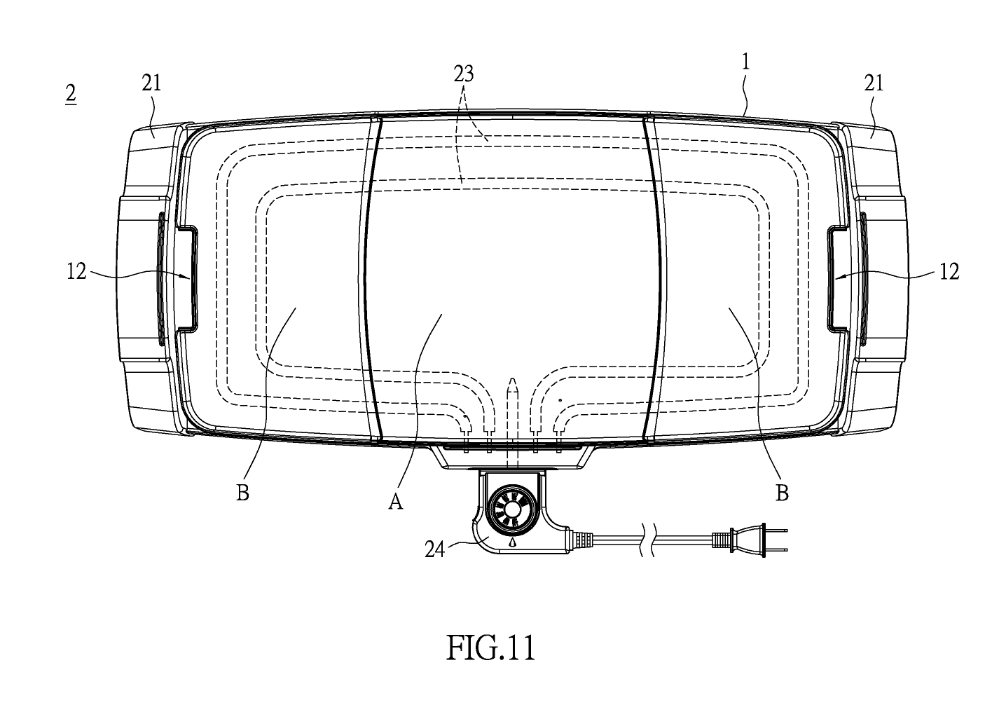

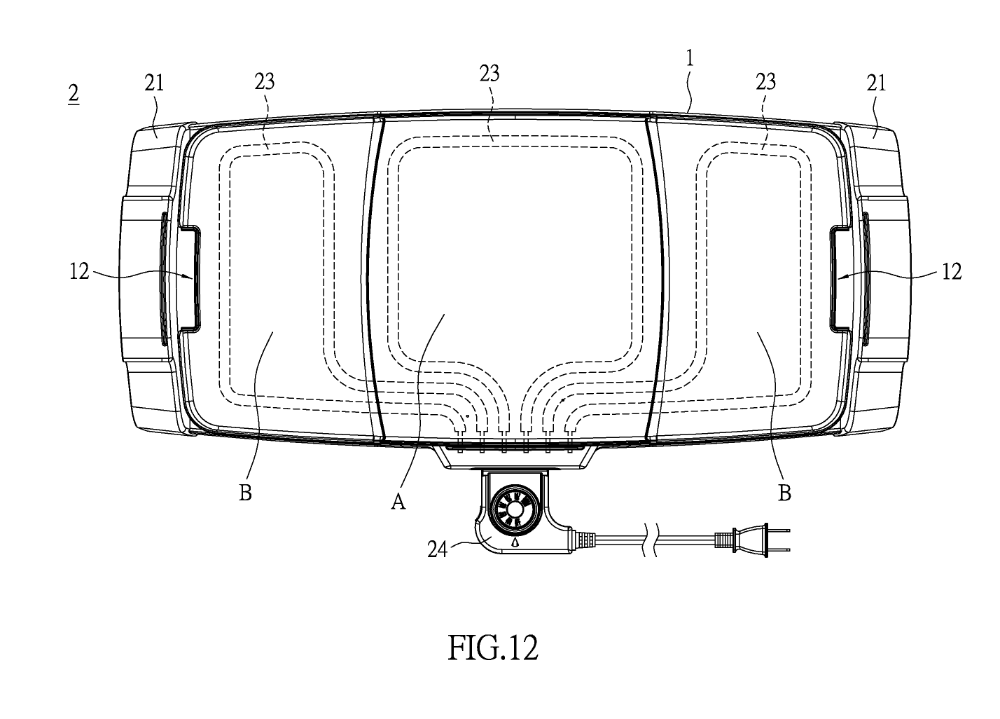

In another implementation, an extra set of heating tube 23 may be disposed at the bottom face of the slanting portions 11, such that the slanting portions 11 have higher heating temperature. For example, as shown in FIG. 11, the outer-loop heating tube 23 (which passes through the flat portion 10) may have lower heating temperature, whereas the inner-loop heating tube 23 (which passes through the slanting portions 11) may have higher heating temperature. As a result, the cooking area for high-fat food B has higher heating temperature than the cooking area for low-fat food A. On the other hand, as shown in FIG. 12, the flat portion 10 and the slanting portions 11 have independent heating tubes 23. The heating tube 23 disposed at the bottom face of the flat portion 10 has lower heat than the heating tubes 23 disposed at the bottom face of the slanting portions 11.

In conclusion, the flat portion and the slanting portions divide cooking area for low-fat food and cooking area for high-fat food. The cooking area for high-fat food is tilted, such that fat can be drained away. The food can be divided according to its property (for example, fat content) and placed on an appropriate cooking surface. The high-fat food and low-fat food can be cooked at the same time and the fat produced by high-fat food during cooking does not contaminate low-fat food.

Furthermore, any fluid from the food (e.g., meat) can be directed to the spout at the beginning of cooking, such that the food does not contact the fluid. Next, the fat produced during cooking can be quick guided by the slanting portion to the spout, such that the food does not contact the fat. The resulting dish is less greasy and healthier. The smoke is greatly reduced because fat does not remain on the grill pan, and the remainder fat is less and therefore the cleaning is easier. Finally, the grill pan cleaning is much easier and faster because the height difference between the high-fat food and low-fat food cooking areas and the fat is drained away during cooking. Less detergent is required to clean the grill pan, and the water quickly dry out on the grill pan because most of it flows away along the slanting portions.

The ribs on the slanting portion separate the high-fat food from its fat during cooking, such that the food is lighter with less fat attached. The draining channels between the ribs effectively drain the fat to the spout. Furthermore, the ribs and the slanting portions prevent the high-fat food from sticking on the grill pan.

The detachable heating tube control unit can be removed after cooking. The entire grill cookware can be washed under water minus the control unit, such that the electronic components are less likely to dysfunction because of moisture.

The cooking areas for low and high-fat food have different heating temperature so as to minimize the cooking time difference for different food materials, and the overall cooking time is therefore shorter.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A grill pan comprising:
a flat portion; and
two slanting portions connected to each side of the flat portion respectively, each of the slanting portions formed with a spout positioned opposite to a connecting portion where the flat portion connects to the slanting portion;
wherein the connecting portion between the flat portion and each of the slanting portions has a height difference, such that the flat portion and each of the slanting portion divide a cooking area for low-fat food and a cooking area for high-fat food, and the slanting portions slope downwardly from the connecting portion to the flat portion, such that fat produced from high-fat food placed on the cooking area for high-fat food during cooking flows downwardly to the spout.

2. The grill pan according to claim 1, wherein the slanting portions have a plurality of ribs to separate fat from food during cooking and a draining channel is formed between each two immediately adjacent ribs.

3. The grill pan according to claim 2, wherein one end of the draining channel is directed toward the spout and drains fat away from the cooking area for high-fat food to the spout during cooking.

4. The grill pan according to claim 2, wherein the ribs are parallel to each other.

5. The grill pan according to claim 2, wherein a width of the draining channel ranges between 3 to 10 mm.

6. The grill pan according to claim 2, wherein the ribs includes a sliding prevention unit.

7. The grill pan according to claim 2, wherein the ribs includes a blocking unit positioned proximately to the spout.

8. The grill pan according to claim 1, wherein the slanting portions are 1 to 10 mm above the flat portion.

9. The grill pan according to claim 1, wherein an angle between a horizontal face and one of the slanting portions ranges between 5 to 15 degrees.

10. The grill pan according to claim 1, wherein an area of the flat portion and an area of each of the slanting portion ranges between 100 to 900 cm².

11. The grill pan according to claim 1, wherein each side of the flat portion is formed with a guiding channel opposite to the spout to allow fluid communication between the flat portion and the slanting portions.

12. A grill cookware comprising:
a base;
a grill pan including:
a flat portion; and
two slanting portions connected to each side of the flat portion respectively, each of the slanting portions formed with a spout positioned opposite to a connecting portion where the flat portion connects to the slanting portion;
wherein the connecting portion between the flat portion and each of the slanting portions has a height difference, such that the flat portion and each of the slanting portion divide a cooking area for low-fat food and a cooking area for high-fat food, and the slanting portions slope downward from the flat portion to allow any liquid on the cooking area for high-fat food to flow toward the spout;
two fat tanks disposed at a position to receive fluid from the spout; and
at least one heating tube disposed along a bottom face of the flat portion and the slanting portion to heat up the grill cookware.

13. The grill cookware according to claim 12, wherein the heating tubes are disposed at the bottom face of the slanting portion to form a high-temperature heating area corresponding to the cooking area for high-fat food.

14. The grill cookware according to claim 12, wherein the heating tube coils at the bottom face of the slanting portion to form a high-temperature heating area corresponding to the cooking area for high-fat food.

15. The grill cookware according to claim 12 further comprising a control unit detachably electrically connected to the heating tube.

16. The grill cookware according to claim 15, wherein the heating tube has two water-proof connecting ends, and the control unit has two electric receptacles corresponding to the two water-proof connecting ends.

17. The grill cookware according to claim 16, wherein the electric receptacles has a clamping portion, an outer face of the control unit has two press elements corresponding to the clamping portion, the clamping portion is releasable from the water-proof electric connecting end by pressing the pressing element, and then the control unit is released from the grill pan.

18. The grill cookware according to claim 12, wherein the slanting portions have a plurality of ribs to separate fat and food during cooking and a draining channel is formed between each two immediately adjacent ribs.

19. The grill cookware according to claim 18, wherein one end of the draining channel is directed toward the spout and drains fat away from the cooking area for high-fat food to the spout during cooking.

20. The grill cookware according to claim 18, wherein the ribs are parallel to each other.

21. The grill cookware according to claim 18, wherein a width of the draining channel ranges between 3 to 10 mm.

22. The grill cookware according to claim 12, wherein the ribs includes a sliding prevention unit.

23. The grill cookware according to claim 12, wherein the ribs includes a blocking unit positioned proximately to the spout.

24. The grill cookware according to claim 12, wherein the slanting portions are 1 to 10 mm above the flat portion.

25. The grill cookware according to claim 12, wherein an angle between a horizontal face and one of the slanting portions ranges between 5 to 15 degrees.

26. The grill cookware according to claim 12, wherein an area of the flat portion and an area of each of the slanting portion ranges between 100 to 900 cm².

27. The grill cookware according to claim 12, wherein each side of the flat portion is formed with a guiding channel opposite to the spout to allow fluid communication between the flat portion and the slanting portions.
